(19) United States
(12) Patent Application Publication
(10) Pub. No.: US 2006/0003211 A1
(43) Pub. Date: Jan. 5, 2006

(54) Non-humidified polymer electrolyte

(76) Inventors: Hee-young Sun, Yongin-si (KR); Ho-sung Kim, Suwon-si (KR); Myung-dong Cho, Hwaseong-si (KR)

Correspondence Address: MCGUIREWOODS, LLP, 1750 TYSONS BLVD, SUITE 1800, MCLEAN, VA, 22102, US

(21) Appl. No.: 11/155,563

(22) Filed: Jun. 20, 2005

(30) Foreign Application Priority Data
Jul. 3, 2004 (KR) 10-2004-0051798

(51) Int. Cl. H01M 8/10

(52) U.S. Cl. 429/30; 429/33

(57) ABSTRACT

The present invention provides a novel non-humidified polymer electrolyte and a fuel cell including the same. The non-humidified polymer electrolyte comprises an ion medium comprising an organic compound that has a boiling point greater than 100° C. and a dielectric constant greater than 3. The non-humidified polymer electrolyte further comprises a matrix comprising an ion conducting polymer, wherein the ion medium is impregnated into the matrix.

### CROSS REFERENCE TO RELATED APPLICATION

This application claims priority to and the benefit of Korean Patent Application No. 10-2004-0051798, filed on Jul. 3, 2004, in the Korean Intellectual Property Office, the disclosure of which is incorporated herein in its entirety by reference.

### BACKGROUND OF THE INVENTION

1. Field of the Invention

The present invention relates to a non-humidified polymer electrolyte. The present invention also relates a fuel cell comprising the non-humidified polymer electrolyte.

2. Description of the Related Art

A polymer that has a dissociating group in its chain is referred to as a polymer electrolyte. When the polymer electrolyte contacts water, its dissociating group is dissociated to form an ion.

A polymer electrolyte membrane refers to a structural body that is in the form of a membrane and is formed using a polymer electrolyte as its main component. A typical polymer electrolyte material is a water insoluble polymer. In the polymer electrolyte membrane, the polymer electrolyte provides a dissociating group and acts as a matrix for maintaining the membrane structure.

The polymer electrolyte is mainly used to form an ion exchange membrane or an ion conductor membrane. For a polymer electrolyte to function as an ion conductor, an ion medium has to be incorporated into the polymer electrolyte matrix. In general, water is used as the ion medium.

The term “polymer electrolyte” herein refers to a polymer electrolyte matrix in which an ion medium is incorporated, as well as a polymer electrolyte matrix itself. A specific example of the polymer electrolyte used as an ion conductor membrane is a polymer electrolyte membrane fuel cell (PEMFC).

A fuel cell is a device that reacts a fuel with oxygen to generate electrical energy. In contrast with thermal power generation, a fuel cell does not go through the Carnot cycle and thus, its theoretical efficiency is very high. Fuel cells are used to power small electronic devices such as portable devices, and are applicable in industry, household, and automobiles.

Fuel cells can be classified based on the type of electrolyte they use, such as PEMFC, phosphoric acid fuel cell (PAFC), molten carbonate fuel cell (MCFC), and solid oxide fuel cell (SOFC), etc. The operating temperature of the fuel cells and the composition of their components vary depending on the type of electrolyte that is used.

Fuel cells can also be classified based on the method of fuel supply such as an exterior reforming type that converts a fuel to a hydrogen enriched gas through a fuel modifier and supplies the gas to an anode. Other types include a direct fuel feeding type or an interior reforming type that directly feeds a fuel in a gas or a liquid state (e.g. natural gas, an aqueous methanol solution, etc.) to an anode.

In general, a direct fuel feeding type fuel cell, such as a direct methanol fuel cell (DMFC), uses an aqueous methanol solution as a fuel and a hydrogen ion conducting polymer electrolyte membrane as an electrolyte. Thus, a DMFC is a type of PEMFC.

Although the PEMFC is small and light, it can provide high output density. Furthermore, by using the PEMFC, a system for generating electricity becomes simple to construct.

The basic structure of the PEMFC typically includes an anode (fuel electrode), a cathode (oxidant electrode), and a polymer electrolyte membrane that is positioned in between the anode and the cathode. The anode of the PEMFC is provided with a catalyst layer to promote oxidation of a fuel, and the cathode of the PEMFC is provided with a catalyst layer to promote reduction of the oxidant.

The fuel that is fed to the anode of the PEMFC typically includes hydrogen, hydrogen-containing gas, a mixed vapor of steam and methanol, aqueous methanol solution, etc. The oxidant that is fed to the cathode of the PEMFC typically includes oxygen, oxygen-containing gas or air.

At the anode of the PEMFC, a fuel is oxidized to form a hydrogen ion and an electron. The hydrogen ion is transferred to the cathode through an electrolyte membrane, and the electron is transferred to an outer circuit (load) through a wire (or a collector). At the cathode of the PEMFC, the hydrogen ion that was transferred through the electrolyte membrane, the electron that was transferred from the outer circuit through a wire (or a collector), and oxygen are combined to form water. The flow of the electron through the anode, the outer circuit and the cathode is electric current.

The polymer electrolyte membrane serves not only as an ion conductor to transfer hydrogen ions from the anode to the cathode, but also as a separator to prevent physical contact between the anode and the cathode. Accordingly, properties required for the polymer electrolyte membrane include excellent ion conductivity, electrochemical stability, strong mechanical strength, thermal stability at operating temperature, and easy thin film making, for example.

The polymer electrolyte membrane generally comprises a polymer electrolyte such as a sulfonate perfluorinated polymer (e.g., Nafion® DuPont) that has a backbone comprising a fluorinated alkylene and a side chain comprising a fluorinated vinyl ether that has a sulfonic acid group at its terminal, and this type of polymer electrolyte membrane shows excellent ion conductivity by retaining a sufficient quantity of water.

However, such an electrolyte membrane may lose its function at operating temperatures greater than 100° C. since its ion conductivity seriously declines due to loss of water by evaporation. Accordingly, it is difficult to operate the PEMFC using this type of polymer electrolyte membrane at atmospheric pressure and a temperature of more than 100° C. Thus, the existing PEMFC is usually operated at a temperature less than 100° C., for example at about 80° C.

Further, the polymer electrolyte can also be used in a catalyst layer of an electrode that is applied in a fuel cell such as a PEMFC or DMFC, for example. The catalyst layer generally includes a catalyst to promote the electrochemical reaction and an ionomer that acts as an ion passage and as a binder. The polymer electrolyte can be used as an ionomer. If loss of water occurs in the polymer electrolyte of the catalyst layer, the polymer electrolyte can no longer function as an ion passage, and the electrochemical reaction of the catalyst layer cannot progress.

When the PEMFC operates at temperatures less than about 100° C., another type of problem may occur. The hydrogen-rich gas is obtained by converting an organic fuel such as a natural gas or methanol. This hydrogen-rich gas comprises carbon dioxide and carbon monoxide as by-products of the conversion reaction. Carbon monoxide has a tendency to poison the catalyst of the cathode and the anode. The electrochemical activity of the poisoned catalyst declines significantly, and thus the operating efficiency and lifespan of the PEMFC seriously decline. At lower operating temperatures of the PEMFC, there is a greater tendency of carbon monoxide to poison the catalyst.

The poisoning of a catalyst with carbon monoxide may also occur even when methanol is used. Methanol is fed to the anode of the PEMFC as an aqueous methanol solution (or a mixed vapor of steam and methanol). At the anode, methanol and water react to generate hydrogen ions and electrons along with carbon monoxide and carbon dioxide by-products.

Further, a PEMFC that operates at temperatures lower than about 100° C. may not be suitable for the cogeneration of electrical and thermal energy.

In order to elevate the operating temperature of the PEMFC to more than 100° C., solutions including mounting a humidifying apparatus on the PEMFC, operating the PEMFC under pressurized conditions, or using a polymer electrolyte that does not require humidification have been suggested.

When the PEMFC is operated under pressurized conditions, the operating temperature can be elevated since the boiling point of water is elevated. For example, when the operating pressure of the PEMFC is 2 atm, the operating temperature can be elevated to about 120° C. However, when a pressurizing system is applied or a humidifying apparatus is mounted, the size and weight of the PEMFC increase and the total efficiency of the power generating system decreases.

Accordingly, in order to maximize the application range of the PEMFC, a non-humidified polymer electrolyte that exhibits excellent ion conductivity without humidification is needed.

An example of a non-humidified polymer electrolyte is disclosed in Japanese Patent Publication No. 1999-503262. It describes several materials, such as polybenzimidazole, sulphuric acid, and phosphoric acid doped polybenzoimidazole that are described as suitable for use as a non-humidified polymer electrolyte.

### SUMMARY OF THE INVENTION

The present invention provides a novel non-humidified polymer electrolyte, a polymer electrolyte membrane comprising a non-humidified polymer electrolyte, an electrode comprising a polymer electrolyte membrane comprising a non-humidified polymer electrolyte, and a fuel cell comprising a polymer electrolyte membrane comprising a non-humidified polymer electrolyte.

Furthermore, the non-humidified polymer electrolyte according to the present invention can apply not only to a fluorine-based polymer, but also to a hydrocarbon-based polymer as a matrix that has a dissociating group. Accordingly, the choice of the material for the non-humidified polymer electrolyte can be widened and the cost for the non-humidified polymer electrolyte can be decreased.

By applying the non-humidified polymer electrolyte described above, the fuel cell according to the present invention may have improved efficiency and a longer lifespan when operating at high temperatures and the simplification of a system for generating electricity can be achieved because a humidifying system is not required.

Additional features of the invention will be set forth in the description which follows, and in part will be apparent from the description, or may be learned by practice of the invention.

The present invention discloses a non-humidified polymer electrolyte comprising an organic compound that has a boiling point greater than 100° C. and a dielectric constant greater than 3 and a matrix comprising an ion-conducting polymer, wherein the ion medium is impregnated into the matrix.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

FIG. 1 is a graph showing the variation in ion conductivity of a polymer electrolyte according to an example of the present invention and a polymer electrolyte according to the comparative example as a function of temperature.

FIG. 2 is a graph showing the variation in ion conductivity of the polymer electrolyte according to an example of the present invention and the polymer electrolyte according to the comparative example as a function of time at 120° C.

### DETAILED DESCRIPTION OF THE ILLUSTRATED EMBODIMENTS

A non-humidified polymer electrolyte according to the present invention comprises an ion medium comprising an organic compound that has a boiling point greater than 100° C. and a dielectric constant more than 3. The electrolyte further comprises a matrix comprising an ion conducting polymer, wherein the ion medium is impregnated into the matrix.

The term “polymer electrolyte” herein refers to an ion conductor comprising a polymer electrolyte matrix in which an ion medium is impregnated. The term “non-humidified polymer electrolyte” refers to a polymer electrolyte that has excellent ion conductivity even when it does not contain water, and maintaining proper ion conductivity even at a temperature more than 100° C. under atmospheric pressure.

A non-humidified polymer electrolyte according to embodiments of the present invention can maintain excellent ion conductivity without losing an ion medium even at temperatures greater than 100° C. under atmospheric pressure. This is possible because the electrolyte uses an organic compound that has a boiling point of more than 100° C. and a dielectric constant more than 3 as the ion medium. Further, since it can retain an ion medium even at temperatures greater than 100° C., the ion conducting polymer matrix is not broken at temperatures above 100° C.

In addition, since an organic compound that has a dielectric constant greater than 3 is used as the ion medium, the dissociating group of the ion conducting polymer matrix can be easily dissociated. This allows the non-humidified polymer electrolyte according to the embodiments of the present invention to have excellent ion conductivity.

The ion medium is an organic compound that may have a boiling point greater than about 100° C., preferably more than about 200° C., and more preferably more than about 300° C. Thus the ion medium can be present in the matrix without being evaporated even at temperatures greater than about 100° C. under atmospheric pressure. Typically, the ion medium has a boiling point in the range of 150° C. to 350° C., more preferably about 200° C. to 300° C. The boiling points mentioned herein are all based on the atmospheric pressure.

The term “dielectric constant” refers to the ratio of the electric capacitance when a dielectric body is inserted between two electrodes of a condenser to the electric capacitance when a dielectric body is not inserted (strictly speaking, vacuum). The larger the dielectric constant of the ion medium, the easier it is to dissociate the dissociating group of the polymer electrolyte. The present inventors found that when the dielectric constant of the ion medium is more than about 3, the ion conductivity of the resulting polymer electrolyte corresponds to a value that is typically required for an ion exchange membrane, particularly a value that is typically required for the PEMFC electrolyte membrane.

According to the present invention, since performance may improve as the dielectric constant of the ion medium increases above 3, it is not necessary to define the upper limit of the dielectric constant. Typically, the ion medium has a dielectric constant of about 3 to 100, and more preferably about 5 to 90. The dielectric constants mentioned herein are all measured at 20° C.

The organic compound used as the ion medium may comprise but is not limited to a cyclic carbonate group, a cyclic carboxylic acid ester group, an ether bond, and a cyan group. The compound has a boiling point greater than 100° C. and a dielectric constant greater than 3. These compounds can be used alone or in combination.

Specific examples of organic compounds having a cyclic carbonate group includes 4-[CH₃(OC₂H₄)ₙCH₂-]-1, 3-dioxolan-2-one as shown in Formula I), a propylene carbonate as shown in Formula II, and ethylene carbonate. The boiling point and the dielectric constants of these compounds are shown in Table 1.

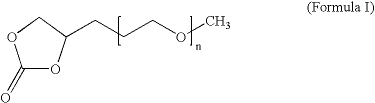

In Formula I, n is an integer between and including 1 and 10, more preferably 2 to 5.

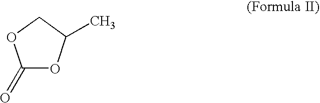

A specific example of an organic compound having a cyclic carboxylic acid ester group includes γ-butyrolactone as shown in Formula III. The boiling point and the dielectric constant of this compound are also shown in Table 1.

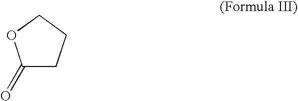

A specific example of an organic compound having an ether bond includes triglyme as shown Formula IV. The boiling point and the dielectric constant of this compound are shown in Table 1. The dielectric constant can be measured using high frequency waves and microwaves, using a capacitor, or an impedance/gain-phase analyzer (HP-4194A).

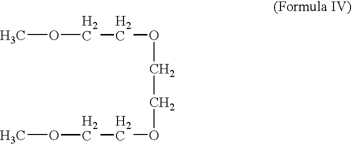

TABLE 1

| | Boiling point @ | Dielectric |
|---|---|---|
| Organic compound | 1 atm (° C.) | constant |
| 4-[CH₃(OC₂H₄)ₙCH₂-]- | 180 | 7.13 |
| 1,3-dioxolan-2-one, | | |
| n = 1 | | |
| Propylene carbonate | 241 | 64.4 |
| γ-butyrolactone | 202 | 39.1 |
| Triglyme | 220 | 7.5 |

Such organic compounds are commercially available and can be prepared by the well-known methods of nucleophilic substituting polymerization or oxidation polymerization.

In the polymer electrolyte according to the present invention, when the concentration of the ion medium is too low, the ion conductivity can become non-uniform or be excessively reduced. When the concentration of the ion medium is too high, the ion medium can become soaked into the electrode, thereby occluding the pore (gas path) of the electrode. Taking these issues into consideration, the concentration of the ion medium may be 10 wt % to 70 wt %, more preferably 30 wt % to 40 wt %, based on the total weight of the polymer electrolyte.

In the polymer electrolyte according to embodiments of the present invention, the ion medium may be impregnated in the polymer matrix. The polymer matrix comprises an ion conducting polymer that has a dissociating group and contains the ion medium while maintaining solid or gel state.

The polymer that has the dissociating group is not dissolved by an organic compound that has a boiling point greater than 200° C. and a dielectric constant greater than 20, and contains a dissociating group in its backbone or side chain.

The polymer used in embodiments of the present invention may contain at least one dissociating group including, but not limited to a sulfonic acid group, a carboxylic acid group, a phosphoric acid group, an imide group, a sulfonimide group, a sulfonamide group and a hydroxyl group.

Examples of the polymer may include but are not limited to trifluoroethylene, tetrafluoroethylene, styrene-divinyl benzene, α,β,β-trifluorostyrene, a styrene, an imide, a sulfone, a phosphazene, an etherether ketone, an ethylene oxide, a polyphenylene sulfide or a homopolymer and a copolymer of an aromatic group, and derivatives thereof. These polymers contain the dissociating groups in their backbones and side chains and can be used alone or in combination with each other.

The polymer can be a highly fluorinated polymer in which the number of fluorine atoms comprises more than 90% of the total atoms that are bonded to the backbone and side chains of the carbon atoms.

The polymer can be a highly fluorinated polymer that uses sulfonated groups as a cation exchange group at the terminal end of its side chain, in which the number of fluorine atoms comprises more than 90% of the total atoms that are bonded to the backbone and side chain of the carbon atoms.

Further, the polymer described in U.S. Pat. Nos. 3,282,875, 4,358,545, 4,940,525, 5,422,411 can be used as the polymer in embodiments of the present invention.

More specific example include a homopolymer made from a MSO₂CFR_{f}CF₂O[CFYCF₂O]ₙCF═CF₂ monomer, and a copolymer made from the above monomer and at least one monomer including but not limited to an ethylene, a halogenated ethylene, a perfluorinated α-olefin, a perfluoro alkyl vinyl ether. In the above formula, R_{f} may be a radical including a fluorine and a C₁-C₁₀ perfluoroalkyl group. Y may be a radical such as fluorine and a trifluoromethyl group, n is an integer ranging from 1 to 3, M may be a radial such as fluorine, a hydroxyl group, an amino group, and an —OMe group. Herein Me is a radical selected from an alkali metal and a quaternary ammonium group.

Further, a polymer that has a backbone that is substantially substituted with a fluorine and pendant groups represented by —O—[CFR′_{f}]_{b}[CFR_{f}]ₐSO₃Y can also be employed as the polymer having a cation exchange group. Herein, a ranges from 0 to 3, b ranges from is 0 to 3, where a+b is at least 1. R_{f} and R′_{f} may be a halogen atom or an alkyl group that is substantially substituted with a fluorine and Y is a hydrogen atom or an alkali metal.

Another example of the polymer includes a sulfonic fluoropolymer that has a fluorine substituted backbone and pendant groups that is represented by ZSO₂-[CF₂]ₐ-[CFR_{f}]_{b}-O—. Here, Z is a halogen atom, an alkali metal, a hydrogen atom or —OR group, where R is a C₁-C₁₀ alkyl group or aryl radical. In addition, a ranges from 0 to 2 and b ranges from 0 to 2, where a+b is not 0. R_{f} may be F, Cl, a C₁-C₁₀ perfluoroalkyl group, or a C₁-C₁₀ fluorochloroalkyl group.

Another example of the polymer includes a polymer represented by the following chemical structure, Formula V.

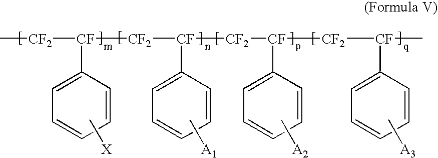

In Formula V, m is an integer larger than 0 and at least one of n, p and q is an integer larger than 0. A₁, A₂, and A₃ may be an alkyl group, a halogen atom, C_{y}F_{2y+1} (where y is an integer larger than 0), an OR group (where R is selected from an alkyl group, a perfluoroalkyl group and an aryl radical), CF═CF₂, CN, NO₂, and OH. X may be from SO₃H, PO₃H₂, CH₂PO₃H₂, COOH, OSO₃H, OPO₃H₂, and OArSO₃H (where Ar means aromatic), NR₃⁺ (where R is selected from an alkyl group, a perfluoroalkyl group and an aryl radical), or CH₂NR₃⁺ (where R is selected from an alkyl group, a perfluoroalkyl group and an aryl radical).

According to the present invention, the specific polymer can be selected by determining its compatibility with a specific organic compound that is used as an ion medium. That is, the polymer must form a matrix in the solid or gel state, and thus a polymer that may not dissolve in the selected organic compound ion medium may be used. Further, the selected organic compound may permeate into the selected ion conducting polymer of the matrix to achieve sufficient impregnation.

A non-humidified polymer electrolyte according to embodiments of the present invention may be fabricated by any method that can be performed by contacting a matrix comprising a polymer having a dissociating group with an organic compound that is used as an ion medium so that the organic compound can permeate the matrix. Such method can be easily selected by those skilled in the art.

Hereinafter, an embodiment of the membrane form of the polymer electrolyte according to embodiments of the present invention will be described in detail. The polymer electrolyte membrane comprises the polymer electrolyte described above.

There is no special limitation on the thickness of the polymer electrolyte membrane according to embodiments of the present invention. However, when the membrane is too thin, the strength of the polymer electrolyte membrane may decrease excessively. When the membrane is too thick, the ion conducting resistance in thickness direction can increase excessively. Taking these factors into consideration, the polymer electrolyte membrane can be about 30 μm to 200 μm thick.

Hereinafter, a method of preparing a polymer electrolyte membrane according to an embodiment of the present invention will be described in detail.

The polymer electrolyte membrane according to embodiments of the present invention can be fabricated by first preparing a film comprising a polymer electrolyte having a dissociating group. A conventional polymer processing method can be employed in the preparation of the polymer electrolyte film. Then, an organic compound ion medium may be impregnated into the matrix for which the film is used. For example, the ion medium can be impregnated into the polymer electrolyte matrix by soaking the polymer electrolyte matrix in the organic compound in a liquid state.

The polymer electrolyte membrane serves as an ion exchange membrane or ion conducting membrane. The PEMFC is a specific type of fuel cell that uses the polymer electrolyte membrane as an ion conducting membrane.

Hereinafter, an electrode for a fuel cell according to embodiments of the present invention will be described in detail.

An electrode for the fuel cell may comprise a catalyst layer comprising a catalyst and an ionomer, wherein the ionomer is the non-humidified polymer electrolyte described above.

The catalyst can be a metal catalyst, a supported catalyst, or mixtures thereof. The metal catalyst refers to a catalyst comprising catalytic metal particles. The supported catalyst refers to a catalyst comprising a porous carrier and catalytic metal particles that are supported on the porous carrier.

Exemplary catalytic metal particles may include but are not limited to titanium (Ti), vanadium (V), chromium (Cr), manganese (Mn), iron (Fe), cobalt (Co), nickel (Ni), copper (Cu), zinc (Zn), aluminum (Al), molybdenum (Mo), selenium (Se), tin (Sn), platinum (Pt), ruthenium (Ru), palladium (Pd), tungsten (W), iridium (Ir), osmium (Os), rhodium (Rh), niobium (Nb), tantalum (Ta), lead (Pb), and mixtures thereof.

Preferably, platinum can be used as the catalytic metal. Another specific example of the catalytic metal includes a platinum-ruthenium alloy with a platinum-ruthenium ratio of about 0.5:1 to 2:1. The platinum-ruthenium alloy is particularly useful in an anode of the DMFC.

When the average particle size of the catalytic metal particles is too small, the catalytic particles cannot promote the catalytic reaction. When the average particle size is too large, the reactive surface area of the total catalytic particles may decrease, which reduces their activity. Taking these factors into consideration, the average particle size of the catalytic metal particles can be about 1 nm to 5 nm.

Carbon black, carbon nanotubes or mesoporous carbon powder, for example can be used as the carrier in the supported catalyst.

When the concentration of the catalytic metal particles in the supported catalyst is too low, the supported catalyst cannot be used in a fuel cell. When the concentration is too high, the particle size of the catalyst may increase. Taking these factors into consideration, the concentration of the catalytic metal particles in the supported catalyst can be about 50 wt % to 70 wt %, based on the total weights of the supported catalyst.

Various known methods for preparing a supported catalyst can be used to prepare the metal catalyst and the supported catalyst. For example, the supported catalyst can be prepared by impregnating a catalytic metal precursor solution into a carrier and then reducing the precursor. Such methods are well known to one of ordinary skill in the art and thus are not described herein in more detail.

In the electrode for a fuel cell according to embodiments of the present invention, the ionomer can function not only as an ion transfer passage, but also as a binder to ensure the mechanical strength of a catalyst layer. Accordingly, the content of the ionomer may be properly selected to ensure an ion transfer passage and mechanical strength.

The electrode for a fuel cell according to embodiments of the present invention may further comprise a gas diffusion layer. The gas diffusion layer can permit a reactant and/or a product to flow evenly in and out of the catalyst layer. A porous electrically conductive material can be used to form the gas diffusion layer. The gas diffusion layer serves as an electric collector and a passageway for a reactant and a product. The gas diffusion layer may include carbon paper, more preferably water-proof carbon paper, and even more preferably water-proof carbon paper in which water-proof carbon black layer is applied. The water-proof carbon paper may comprise a hydrophobic polymer such as polytetrafluoroethylene (PTFE), for example, wherein the hydrophobic polymer is sintered. Water proofing of the gas diffusion layer may simultaneously ensure a passageway for both a liquid reactant and a gas reactant. A water-proof carbon black layer may comprise carbon black and a hydrophobic polymer such as PTFE, etc. as a hydrophobic binder that is attached to one side of the water-proof carbon paper described above. The hydrophobic polymer of the water-proof carbon black layer may be sintered.

The electrode for a fuel cell according to embodiments of the present invention can be used as a cathode and/or as an anode of a fuel cell. The electrode for a fuel cell can be prepared by various known methods of preparing an electrode for a fuel cell. Such methods are well known to those of ordinary skill in the art and thus are not described herein in more detail.

Hereinafter, a fuel cell according to embodiments of the present invention will be described in detail.

A fuel cell according to embodiments of the present invention may comprise a cathode, an anode, and an electrolyte membrane placed between the cathode and the anode. At least one of the cathode, the anode, and the electrolyte membrane comprise the non-humidified polymer electrolyte described above.

The fuel cell can be applied to a PEMFC or a DMFC. The fuel cell comprises the non-humidified polymer electrolyte, and thus may be effectively operated at temperatures greater than and less than 100° C.

An exemplary embodiment of the fuel cell according to the present invention is described as follows.

The cathode comprises a catalyst layer to promote the reduction of oxygen. The catalyst layer comprises catalyst particles and a polymer that has a cation exchange group. Carbon supported platinum (Pt/C) can be used as the catalyst.

The anode comprises a catalyst layer that promotes the oxidation of a fuel such as hydrogen, hydrogen-containing gas, methanol, and ethanol, for example. The catalyst layer comprises catalyst particles and a polymer that has a cation exchange group. Specific examples of the catalyst include a platinum catalyst, a carbon supported platinum catalyst, a platinum-ruthenium catalyst, a carbon supported platinum-ruthenium catalyst, etc. Particularly, a platinum-ruthenium catalyst or a carbon supported platinum-ruthenium catalyst may directly supply an organic fuel other than hydrogen to an anode.

The catalyst used in the cathode and the anode can be the catalytic metal particle itself, or a supported catalyst comprising the catalytic metal particles and a catalytic carrier. Solid particles, such as conductive carbon powders that comprise micropores that are capable of supporting catalytic metal particles can be used as the catalytic carrier. The carbon powders include carbon black, Ketjenblack, acetylene black, activated carbon powder, carbon nanofiber powder, or mixtures thereof. The polymer described above can be used as the polymer that has a cation exchange group.

The catalyst layers of the cathode and the anode may contact the polymer electrolyte membrane.

The cathode and the anode may further comprise a gas diffusion layer in addition to the catalyst layer. The gas diffusion layer comprises a porous material having electric conductivity. The gas diffusion layer plays roles as an electric collector and a passage of a reactant and a product. The gas-diffusion layer includes carbon paper, more preferably water-proof carbon paper, even more preferably water-proof carbon paper in which water-proof carbon black layer is applied. The water-proof carbon paper comprises a hydrophobic polymer such as PTFE (polytetrafluoroethylene), etc., wherein the hydrophobic polymer is sintered. Water proofing of the gas diffusion layer is to ensure the passage for both a liquid reactant and a gas reactant simultaneously. In the water-proof carbon paper having a water-proof carbon black layer, the water-proof carbon black layer comprises carbon black; and a hydrophobic polymer such as PTFE, etc. as a hydrophobic binder, and is attached to one side of the water-proof carbon paper described above. The hydrophobic polymer of the water-proof carbon black layer is sintered.

The cathode, anode, and electrolyte membrane can be prepared using various other materials, and may have various structures and forms. Further, the cathode, the anode, the electrolyte membrane, and the fuel cell of embodiments of the present invention can be prepared by various known methods described in various literature sources and thus are not described herein in more detail.

As described above, in the fuel cell according to the present invention, at least one of the cathode, the anode, and the electrolyte membrane may contain the non-humidified polymer electrolyte mentioned above. The detailed description of the cathode, the anode, and the electrolyte membrane containing the non-humidified polymer electrolyte is the same as that of the electrode for a fuel cell and an electrolyte membrane for a fuel cell mentioned above.

The present invention will be described in greater detail with reference to the following examples. The following examples are for illustrative purposes only and are not intended to limit the scope of the invention.

### EXAMPLES

### Example 1

### MC/Nafion® 117

In this example, a polymer electrolyte membrane using modified carbonate (MC) as an ion medium and the Nafion® 117 as a polymer electrolyte matrix was prepared.

MC is a common name for the compound of Formula I. In this example, MC wherein n=2 was used. The Nafion® 117 is a polymer electrolyte film that belongs to the sulfonate highly fluorinated polymer series, commercially available from DuPont.

First, the Nafion® 117 was soaked in a mixed solution of 30 vol % of 20 mL of hydrogen peroxide and 200 mL of distilled water for 1 hour, and dried at 80° C. for 1 hour. Thus-treated, Nafion® 117 was soaked in a mixed solution of 5.42 mL of 98 wt % of an aqueous sulphuric acid solution and 200 mL of distilled water for 1 hour, and dried at 80° C. for 1 hour. The resulting Nafion® 117 was washed with distilled water and dried at 80° C. for 1 hour.

The washed Nafion® 117 was dried in a 105° C. vacuum oven for 1 hour, and soaked in MC at 80° C. for 1 hour to prepare a polymer electrolyte membrane that has a 40 wt % concentration of MC.

### Example 2

### PC/Nafion® 117

A polymer electrolyte membrane was prepared according to the same method as in Example 1 except that propylene carbonate (PC) was used as the ion medium. Here, the concentration of PC was 43 wt %.

### Example 3

### GBL/Nafion® 117

A polymer electrolyte membrane was prepared according to the same method as in Example 1 except that γ-butyrolactone (GBL) was used as the ion medium. Here, the concentration of GBL was 49 wt %.

### Comparative Example 1: Water/Nafion® 117

A polymer electrolyte membrane was prepared according to the same method as in Example 1 except that water was used as the ion medium. Here, the concentration of water was 24 wt %.

Performance Evaluation

Performance Evaluation 1: Ion Conductivity Depending on Temperature

The ion conductivity for the polymer electrolyte membranes obtained from Example 1, Example 2, Example 3, and Comparative Example 1 were measured at various temperatures and compared.

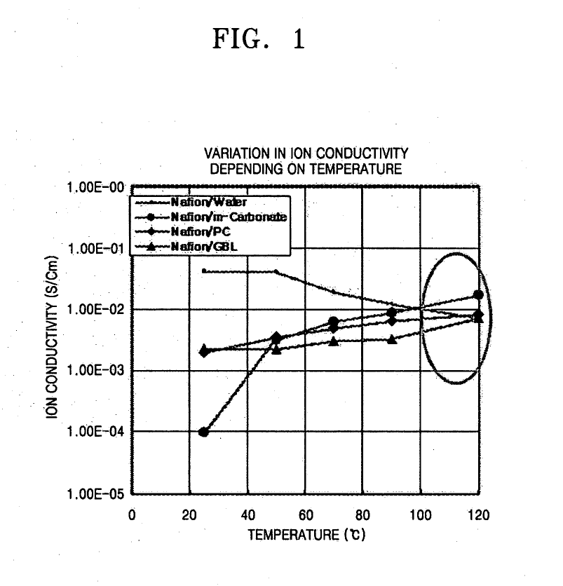

The ion conductivity was measured at 25° C., 70° C., 90° C., and 120° C. using an Hz-3000 Automatic Polarization System and a NF Electronic Instruments 5080 Frequency Response Analyzer. The results are summarized in Table 2 and FIG. 1.

TABLE 2

| Sample of the polymer | | Ion conductivity (S/cm) | | | |
|---|---|---|---|---|---|
| electrolyte membrane | Composition | 25° C. | 70° C. | 90° C. | 120° C. |
| Example 1 | MC/Nafion ® 117 | 0.0001 | 0.0062 | 0.0088 | 0.0170 |
| Example 2 | PC/Nafion ® 117 | 0.0020 | 0.0049 | 0.0064 | 0.0082 |
| Example 3 | GBL/Nafion ® 117 | 0.0023 | 0.0030 | 0.0033 | 0.0073 |
| Comp. Example 1 | Water/Nafion ® 117 | 0.0420 | 0.0190 | 0.0123 | 0.0072 |

As shown in Table 2, the ion conductivities of the sample polymer electrolyte membranes from Example 1, Example 2, and Example 3 were lower than that of Comparative Example 1 at temperatures lower than 90° C. However, the electrolyte membranes of the Example 1, Example 2, and Example 3 showed some level of ion conductivity, and thus may still be used as an ion exchange membrane or an ion conducting membrane.

The ion conductivity of Example 1, Example 2, and Example 3 was the same as or higher than that of the Comparative Example 1 at 120° C. Especially, the electrolyte membrane of Example 1 showed significantly higher ion conductivity than Comparative Example 1.

Such results indicate that the non-humidified polymer electrolyte membrane of the present invention can be used as an ion exchange membrane or an ion conducting membrane at various temperatures. In particular, it can be anticipated that at high temperatures greater than 100° C., the performance is the same as or better than that of the conventional humidified polymer electrolyte membrane.

Performance Evaluation 2: Variation in Ion Conductivity as a Function of Time at 120° C.

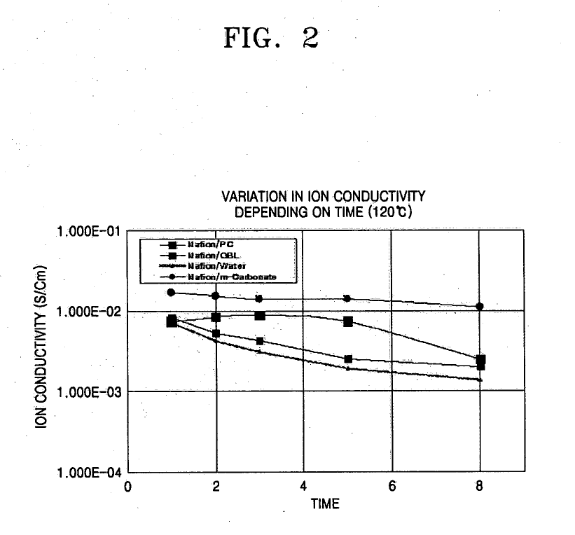

The ion conductivity of the polymer electrolyte membranes obtained from Example 1, Example 2, Example 3, and Comparative Example 1 were measured at various times at 120° C. The results are summarized in Table 3 and FIG. 2.

TABLE 3

| Sample of the polymer | | 120° C. ion conductivity (S/cm) | | | | |
|---|---|---|---|---|---|---|
| electrolyte membrane | Composition | 1 hr | 2 hr | 3 hr | 5 hr | 8 hr |
| Example 1 | MC/Nafion ®117 | 0.0170 | 0.0150 | 0.0140 | 0.0140 | 0.0100 |
| Example 2 | PC/Nafion ® 117 | 0.0082 | 0.0053 | 0.0043 | 0.0025 | 0.0020 |
| Example 3 | GBL/Nafion ® 117 | 0.0073 | 0.0084 | 0.0088 | 0.0073 | 0.0025 |
| Comp. example 1 | water/Nafion ® 117 | 0.0072 | 0.0042 | 0.0031 | 0.0019 | 0.0014 |

As shown in Table 3, the ion conductivity of the electrolyte membrane of the Comparative Example 1 drastically decreased as time lapsed. This occurred because the water that functioned as an ion medium was removed by evaporation from the polymer electrolyte matrix.

The ion conductivity of membranes from Example 2 and Example 3 also decreased as time lapsed. However, the rate of decrease was slower than for the membrane in Comparative Example 1 and the value of the ion conductivity was also maintained at a higher level than Comparative Example 1. The ion conductivity of Example 1 as time lapsed was higher than the ion conductivity of Comparative Example 1.

This occurred because the organic compounds that were used as the ion mediums for Example 1, Example 2, and Example 3 were not removed by evaporation even at 120° C., and instead remained in the polymer electrolyte matrix.

These results indicate that the non-humidified polymer electrolyte membrane according to embodiments of the present invention may function as an ion exchange membrane or an ion conducting membrane at high temperature conditions.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. A polymer electrolyte, comprising:
an ion medium comprising an organic compound having a boiling point greater than 100° C. and a dielectric constant greater than 3; and
a matrix comprising an ion-conducting polymer,
wherein the ion medium is impregnated into the matrix.

2. The polymer electrolyte of claim 1,
wherein the organic compound is a compound that has at least one selected from the group consisting of a cyclic carbonate group, a cyclic carboxylic acid ester group, an ether bond and a cyan group, or mixtures thereof.

3. The polymer electrolyte of claim 1,
wherein the organic compound is 4-[CH₃(OC₂H₄)ₙCH₂-]-1, 3-dioxolan-2-one, a propylene carbonate, a γ-butyrolactone, a triglyme, an acrylonitrile oligomer, or mixtures thereof, and
wherein n is an integer in a range of 2 to 5.

4. The polymer electrolyte of claim 1,
wherein a concentration of the ion medium is 10 wt % to 40 wt %, based on the total weight of the polymer electrolyte.

5. The polymer electrolyte of claim 1,
wherein the ion-conducting polymer has at least one cation exchange group selected from the group consisting of a sulfonic acid group, a carboxylic acid group, a phosphoric acid group, an imide group, a sulfonimide group, a sulfonamide group and a hydroxyl group.

6. The polymer electrolyte of claim 1,
wherein the ion-conducting polymer is a polymer that has a cation exchange group, and is selected from the group consisting of a trifluoroethylene, a tetrafluoroethylene, a styrene-divinyl benzene, an α, β, β-trifluorostyrene, a styrene, an imide, a sulfone, a phosphazene, an etherether ketone, an ethylene oxide, a polyphenylene sulfide or a homopolymer and a copolymer of an aromatic group, and derivatives thereof, and mixtures thereof.

7. The polymer electrolyte of claim 1,
wherein the ion-conducting polymer is a highly fluorinated polymer comprising sulfonate groups and has a sulfonic acid group as a cation exchange group in a terminal end of its side chain, and in which fluorine atoms comprise more than 90% of a total number of the fluorine atoms and hydrogen atoms that are bonded to the carbon atoms in its backbone and side chain.

8. A polymer electrolyte membrane, comprising:
the polymer electrolyte of claim 1.

9. The polymer electrolyte membrane of claim 8,
wherein a polymer electrolyte membrane is about 30 μm to 200 μm thick.

10. An electrode for a fuel cell, comprising:
a catalyst layer comprising a catalyst and an ionomer,
wherein the ionomer is the polymer electrolyte of claim 1.

11. The electrode of claim 10,
wherein the electrode further comprises a gas diffusion layer.

12. A fuel cell, comprising:
a cathode;
an anode; and
an electrolyte membrane between the cathode and the anode;
wherein at least one of the cathode, the anode and the electrolyte membrane comprises the polymer electrolyte of claim 1.
